(19) United States
(12) Patent Application Publication
(10) Pub. No.: US 2026/0073891 A1
(43) Pub. Date: Mar. 12, 2026

(54) METHOD FOR PERFORMING CONSUMER ELECTRONICS CONTROL COMMUNICATION WITH REMOTE DEVICE HAVING HIGH-DEFINITION MULTIMEDIA INTERFACE PORT WITH AID OF MULTIPLE VIRTUAL NETWORK BLOCKS, AND ASSOCIATED APPARATUS

(71) Applicant: Realtek Semiconductor Corp., HsinChu (TW)

(72) Inventors: Cheng-Mao Chi, HsinChu (TW); Ching-Sheng Cheng, HsinChu (TW); Ching-Jui Lee, Hsinchu (TW); Pui-Kei Leong, Hsinchu (TW)

(73) Assignee: Realtek Semiconductor Corp., HsinChu (TW)

(21) Appl. No.: 19/267,674

(22) Filed: Jul. 14, 2025

Related U.S. Application Data
(60) Provisional application No. 63/692,185, filed on Sep. 9, 2024.

(30) Foreign Application Priority Data
Apr. 14, 2025 (TW) 114113969

(51) Int. Cl. G09G 5/00

(52) U.S. Cl. CPC G09G 5/006; G09G 2370/06; G09G 2370/12

(57) ABSTRACT

A method for performing consumer electronics control (CEC) communication with a remote device having high-definition multimedia interface (HDMI) port with aid of multiple virtual network blocks (VNBs) and associated apparatus are provided. The method may include: utilizing a first VNB among the multiple VNBs to receive a first message from a first device through a first CEC line; utilizing the first VNB to convert the first message into a first packet, for performing cross-CEC-line transmission; utilizing the first VNB to transmit the first packet to a second VNB among the multiple VNBs; utilizing the second VNB to convert the first packet into a second message, the messages conforming to predetermined frame format; and utilizing the second VNB to transmit the second message to the remote device through a second CEC line, to allow the first device to indirectly perform the CEC communication with the remote device via the cross-CEC-line transmission.

### CROSS REFERENCE TO RELATED APPLICATIONS

This application claims the benefit of U.S. Provisional Application No. 63/692,185, filed on Sep. 9, 2024. The content of the application is incorporated herein by reference.

### BACKGROUND OF THE INVENTION

### 1. Field of the Invention

The present invention is related to audiovisual systems, and more particularly to a method for performing consumer electronics control (CEC) communication with a remote device having a high-definition multimedia interface (HDMI) port with aid of multiple virtual network blocks (VNBs), and associated apparatus.

### 2. Description of the Prior Art

According to the related art, HDMI-compliant products can communicate with one another via HDMI cables, particularly using the CEC protocol, but the effective communication range is constrained by the maximum length of the HDMI cable, for example, from 10 to 20 meters depending on various factors. There are some other problems in the related art. Although the CEC network in accordance with the standard may be expanded via physical CEC lines, for two separate and independent CEC lines such as a primary CEC line and a secondary CEC line, the respective CEC devices thereof such as that respectively residing on these CEC lines cannot communicate with each other. To date, it seems that there is no proper solution in the related art. Thus, a novel method and associated architecture are needed for solving the problems without introducing any side effect or in a way that is less likely to introduce a side effect.

### SUMMARY OF THE INVENTION

It is an objective of the present invention to provide a method for performing CEC communication with a remote device having an HDMI port with aid of multiple VNBs, and associated apparatus such as a CEC over Internet Protocol (CoIP) device, a multimedia processing device, and a CEC virtual network, in order to solve the above-mentioned problem.

At least one embodiment of the present invention provides a method for performing CEC communication with a remote device having an HDMI port with aid of multiple VNBs. The method may comprise: utilizing a first VNB among the multiple VNBs to receive a first message from a first device through a first CEC line, wherein the first message conforms to a predetermined frame format; utilizing the first VNB to convert the first message into a first packet, for performing cross-CEC-line transmission; utilizing the first VNB to transmit the first packet to a second VNB among the multiple VNBs, wherein the first packet is transmitted directly or indirectly from the first VNB to the second VNB; utilizing the second VNB to convert the first packet into a second message, wherein the second message conforms to the predetermined frame format; and utilizing the second VNB to transmit the second message to the remote device through a second CEC line, to allow the first device to indirectly perform the CEC communication with the remote device via the cross-CEC-line transmission.

At least one embodiment of the present invention provides a CoIP device that operates according to the method mentioned above, where the CoIP device may comprise: the first VNB, configured to at least perform communication with the remote device through the second VNB for the first device; and at least one HDMI port, coupled to the first VNB, configured to at least connect the first device to the CoIP device. In addition, the first VNB may comprise: a first communication interface circuit, configured to communicate with a second communication interface circuit within the second VNB for the first VNB, to allow the first and the second VNBs to perform packet exchange.

At least one embodiment of the present invention provides a multimedia processing device that operates according to the method mentioned above, where the multimedia processing device may comprise: the first device, configured to generate the first message, for performing the CEC communication; the first VNB, coupled to the first device, configured to at least perform communication with the remote device through the second VNB for the first device; and a first HDMI port, coupled to the first device and the first VNB, configured to connect another device to the multimedia processing device. In addition, the first device may comprise: a multimedia processing circuit, configured to perform multimedia processing for the multimedia processing device, wherein the multimedia processing comprises at least one of video/image processing and audio processing. Further, the first VNB may comprise: a first communication interface circuit, configured to communicate with a second communication interface circuit within the second VNB for the first VNB, to allow the first and the second VNBs to perform packet exchange.

At least one embodiment of the present invention provides a CEC virtual network that operates according to the method mentioned above, where the CEC virtual network may comprise the first device, the remote device, and the multiple VNBs.

At least one embodiment of the present invention provides a VNB for performing CEC communication, where the VNB is one of multiple VNBs, and exists independently without being connected to any CEC line or to any first or remote device, and is ready for use to perform cross-CEC-line transmission for the aforementioned any first or remote device after being coupled to the aforementioned any first or remote device via the aforementioned any CEC line. For example, the remaining VNBs among the multiple VNBs except the VNB may comprise the first and the second VNBs mentioned above, for operating according to the method mentioned above.

It is an advantage of the present invention that, through appropriate design, the method of the present invention, the multimedia processing device, and the CEC virtual network can enhance the flexibility in constructing the whole multimedia system. More particularly, in a situation where some apparatus such as the first device and the remote device are too far apart to be connected by using any HDMI cable, the proposed method can arbitrarily connect and/or extend the CEC network beyond the inherent limitations of HDMI cables (e.g., the length restrictions) through using packet forwarding such as network packet forwarding (the network may be used, but it is not limited to using the network), to make these apparatus be capable of discovering and communicating with each other even if they are far apart. Additionally, the method of the present invention, the multimedia processing device, and the CEC virtual network can solve the problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a CEC virtual network according to an embodiment of the present invention, where the CEC virtual network can operate based on a method for performing CEC communication with a remote device having an HDMI port with aid of multiple VNBs.

FIG. 2A illustrates a single-CEC-line control scheme.

FIG. 2B illustrates a multi-CEC-line control scheme.

FIG. 3 illustrates a CoIP control scheme of the method according to an embodiment of the present invention.

FIG. 4 illustrates a non-embedded VNB control scheme of the method according to an embodiment of the present invention, where multiple CoIP devices involved with the non-embedded VNB control scheme can operate according to the method.

FIG. 5 illustrates an embedded VNB control scheme of the method according to an embodiment of the present invention, where multiple multimedia processing devices involved with the embedded VNB control scheme can operate according to the method.

FIG. 6 illustrates a working flow of a VNB transmission (TX) control scheme of the method according to an embodiment of the present invention.

FIG. 7 illustrates a working flow of a VNB reception (RX) control scheme of the method according to another embodiment of the present invention.

FIG. 8 illustrates another version of the CEC virtual network shown in FIG. 1.

FIG. 9 illustrates yet another version of the CEC virtual network shown in FIG. 1.

### DETAILED DESCRIPTION

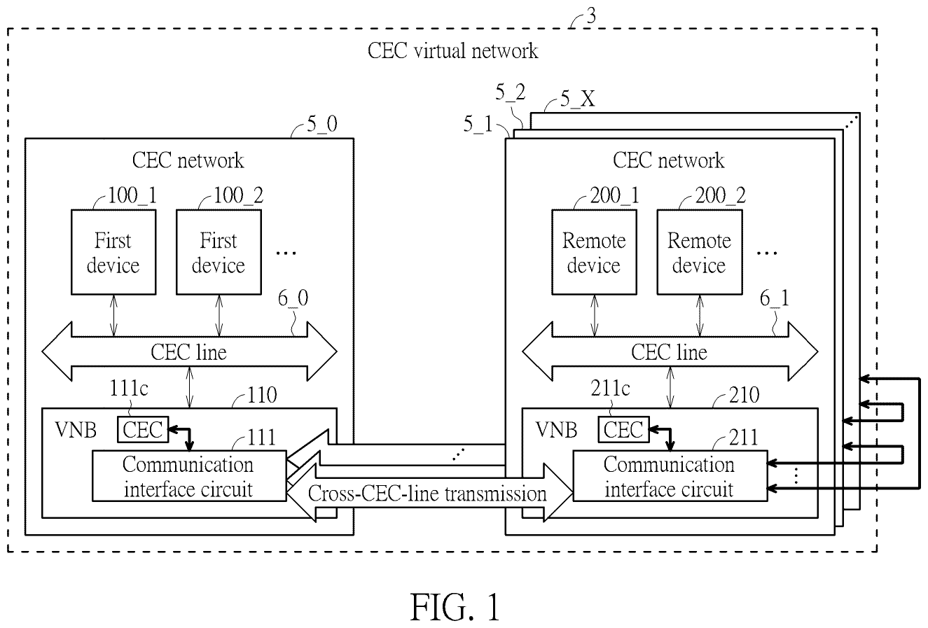

FIG. 1 illustrates a CEC virtual network 3 according to an embodiment of the present invention, where the CEC virtual network 3 is operable in accordance with a method for performing CEC communication with a remote device having an HDMI port with aid of multiple VNBs. Assuming that “X” represents a positive integer, the CEC virtual network 3 may comprise multiple CEC networks independent of each other, such as the (X+1) CEC networks {5_0, 5_1, . . . , 5_X}, and any CEC network 5_x (e.g., “x” may represent any integer within the interval [0, X]) among these CEC networks may comprise a CEC line 6_x and a plurality of HDMI-CEC-compatible devices (which may also be referred to as “the CEC devices” for brevity) that are coupled to each other via the CEC line 6_x, such as the devices capable of communicating with each other according to the CEC protocol. For better comprehension, the devices within the CEC network 5_0 corresponding to x=0 may be referred to as the first devices, while the devices within any CEC network 5_x among the CEC networks {5_x|x>0} corresponding to x>0 may be referred to as the remote devices. The CEC network 5_0 may comprise the CEC line 6_0, the first devices {100_1, 100_2, . . . } that are coupled to each other via the CEC line 6_0, and a VNB 110 configured to provide cross-CEC-line transmission for the CEC network 5 0, where the VNB 110 may comprise a communication interface circuit 111 configured to perform communication such as wired and/or wireless communication with a corresponding communication interface circuit within at least one other VNB (e.g., the VNB 210) for the VNB 110, to allow these VNBs to perform packet exchange between them; the CEC network 5_1 may comprise the CEC line 6_1, the remote devices {200_1, 200_2, . . . } that are coupled to each other via the CEC line 6_1, and a VNB 210 configured to provide cross-CEC-line transmission for the CEC network 5_1, where the VNB 210 may comprise a communication interface circuit 211 configured to perform communication such as wired and/or wireless communication with a corresponding communication interface circuit within at least one other VNB (e.g., the VNB 110) for the VNB 210, to allow these VNBs to perform packet exchange between them; and the rest can be deduced by analogy. The respective VNBs 110, 210, etc. of the CEC networks {5_x|x=0, 1, . . . , X} can be equipped with CEC conversion circuits such as the CEC conversion circuits 111c, 211c, etc. (labeled “CEC” for brevity), for performing conversion between the CEC protocol and the communication protocol used for cross-CEC-line transmission. The respective VNBs 110, 210, etc. of the CEC networks {5_x|x=0, 1, . . . , X} can perform cross-CEC-line transmission among one another, as indicated by the arrows between these CEC networks {5_x} (or the VNBs thereof). According to some embodiments, the respective internal architectures of the CEC networks {5_x|x=0, 1, . . . , X}, the CEC network count (X+1) of the CEC networks {5_x|x=0, 1, . . . , X}, and/or the connections between the CEC networks {5_x|x=0, 1, . . . , X} may vary.

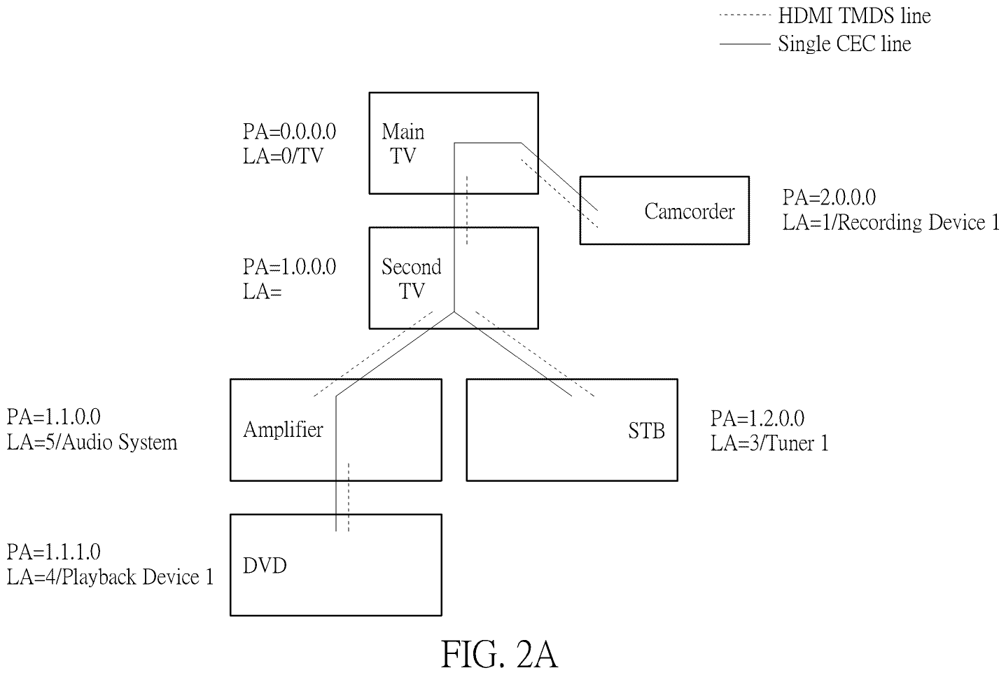

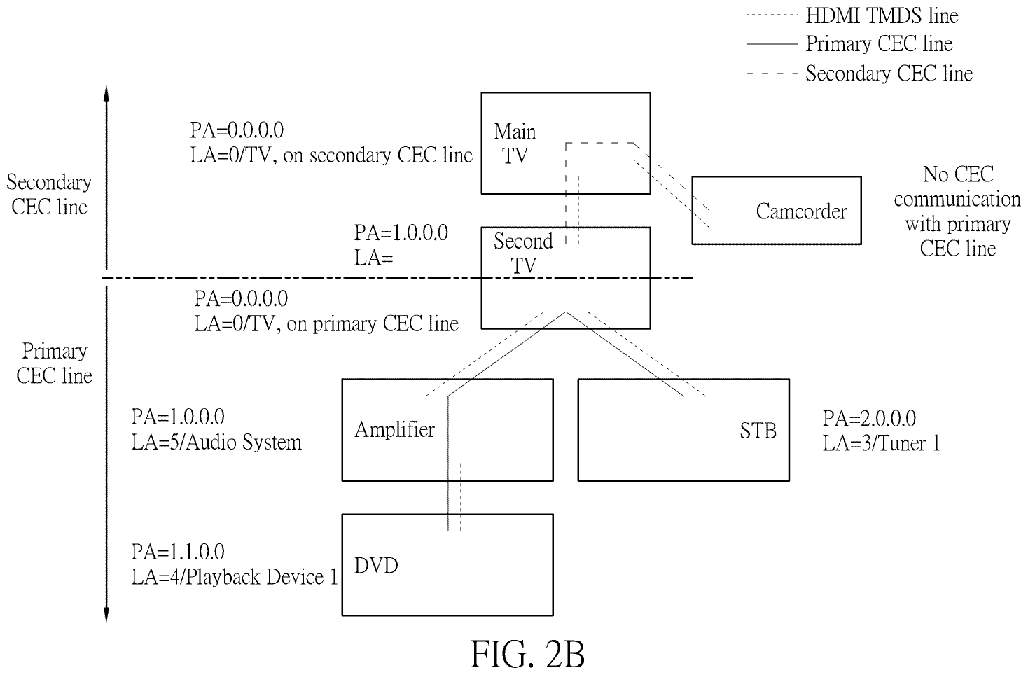

FIG. 2A and FIG. 2B illustrate a single-CEC-line control scheme and a multi-CEC-line control scheme, respectively. For better comprehension, assume that the CEC virtual network 3 may temporarily disable the cross-CEC-line transmission functionality of all VNBs such as the VNBs 110, 210, etc. to operate according to the single-CEC-line control scheme or the multi-CEC-line control scheme, but the present invention is not limited thereto. Examples of the aforementioned CEC devices may include, but are not limited to: multiple televisions (TVs) such as a main TV and a second TV, a camcorder, an amplifier, a digital versatile disc (DVD) player (labeled “DVD” for brevity), and a set-top box (STB). In the single-CEC-line control scheme, by using multiple HDMI transition-minimized differential signaling (TMDS) lines and a single CEC line, some CEC devices may be coupled to each other to form a CEC network. In the multi-CEC-line control scheme, by using multiple HDMI TMDS lines and multiple CEC lines such as a primary CEC line and a secondary CEC line, some CEC devices may be coupled to each other to form multiple CEC networks. Multiple physical addresses {PA} such as the physical addresses {PA(1), PA(2), . . . } and multiple logical addresses {LA} such as the logical addresses {LA(1), LA(2), . . . } can be configured/allocated as shown in FIG. 2A in the single-CEC-line control scheme or as shown in FIG. 2B in the multi-CEC-line control scheme. According to some embodiments, the physical and the logical addresses may vary based on the topology and the devices present in the system. As the inherent limitations of the HDMI cable maximum length should be considered in the single-CEC-line control scheme, in a situation where some devices are too far apart, these devices cannot be connected by using the HDMI cable(s). Additionally, in the multi-CEC-line control scheme, the respective CEC devices of the primary CEC line and the secondary CEC line, such as that respectively residing on these CEC lines, are not capable of communicating with each other, and therefore inhibiting the implementation of full CEC functionality. Based on one or more control schemes of the method, the CEC virtual network 3 can perform cross-CEC-line transmission by using the multiple VNBs to enhance the overall performance. More particularly, in a situation where some devices such as the first devices {100_1, 100_2, . . . } and the remote devices {200_1, 200_2, . . . } are too far apart to be connected by using any HDMI cable, the proposed method can arbitrarily connect and/or extend the CEC network beyond the inherent limitations of HDMI cables through using packet forwarding such as network packet forwarding (the network may be used, but it is not limited to using the network), to make these devices be capable of discovering and communicating with each other even if they are far apart.

The CEC virtual network 3, along with the first devices {100_1, 100_2, . . . }, the remote devices {200_1, 200_2, . . . } and the VNBs 110, 210, etc. therein, can operate according to the method to achieve optimal performance, and more particularly, emulate for any first/other device the operations of any first/other device located in any different CEC network 5_x by using the VNBs 110, 210, etc., to make the respective devices of any two CEC networks {5_x} among the CEC networks {5_x|x=0, 1, . . . , X} recognize and interact with each other while regarding all devices as within the same CEC network, as if they reside within the same CEC network. Taking the CEC networks 5_0 and 5_1 as an example, the associated operations of the method may comprise:
(1) the CEC virtual network 3 can utilize a first VNB among the multiple VNBs, such as the VNB 110, to receive a first message from a first device such as any first device 100_j among the first devices {100_j|j=1, 2, . . . } through a first CEC line such as the CEC line 6_0, where the first message conforms to a predetermined frame format;
(2) the CEC virtual network 3 can utilize the VNB 110 to convert the first message into a first packet, for performing cross-CEC-line transmission;
(3) the CEC virtual network 3 can utilize the VNB 110 to transmit the first packet from the VNB 110 to a second VNB such as the VNB 210;
(4) the CEC virtual network 3 can utilize the VNB 210 to convert the first packet into a second message, where the second message conforms to the predetermined frame format; and
(5) the CEC virtual network 3 can utilize the VNB 210 to transmit the second message to the remote device such as any remote device 200_k among the remote devices {200_k|k=1, 2, . . . } through a second CEC line such as the CEC line 6_1, to allow the first device 100_j to indirectly perform the CEC communication with the remote device 200_k via the cross-CEC-line transmission;
where the first CEC line such as the CEC line 6_0 and the second CEC line such as the CEC line 6_1 are CEC lines independent of each other.

As shown in the left half part of FIG. 1, a first set of devices may comprise the first devices {100_1, 100_2, . . . } and the VNB 110, and may be coupled to each other through the first CEC line such as the CEC line 6_0. As shown in the right half part of FIG. 1, a second set of devices may comprise the remote devices {200_1, 200_2, . . . } and the VNB 210, and may be coupled to each other through the second CEC line such as the CEC line 6_1. The CEC virtual network 3 may utilize the first VNB such as the VNB 110 or the second VNB such as the VNB 210 to perform logical address configuration on the first set of devices and the second set of devices, to make respective logical addresses {LA} of all devices corresponding to the first and the second CEC lines such as the CEC lines 6_0 and 6_1) be different from each other, where the aforementioned all devices may comprise the first set of devices and the second set of devices. In addition, the CEC virtual network 3 may utilize the first VNB such as the VNB 110 or the second VNB such as the VNB 210 to emulate the operations of the remote device 200_k for (or with respect to) the first device 100_j in accordance with the predetermined frame format to make the first device 100_j regard/perceive the remote device 200_k as being or residing on the same CEC line 6_0, and to emulate the operations of the first device 100_j for (or with respect to) the remote device 200_k in accordance with the predetermined frame format to make the remote device 200_k regard/perceive the first device 100_j as being or residing on the same CEC line 6_1, to allow the first device 100_j to indirectly perform the CEC communication with the remote device 200_k via the cross-CEC-line transmission.

TABLE 1

| Name | Description |
|---|---|
| Start | Special start ‘bit’ |
| Header Block | Source and Destination addresses |
| Data Block 1 | Opcode |
| (opcode block) | (optional) |
| Data Block 2 | Operand(s) specific to opcode |
| (operand blocks) | (optional, depending on opcode) |

TABLE 2
Header/Data Block

| | | | | | | | |
|---|---|---|---|---|---|---|---|
| 7 | 6 | 5 | 4 | 3 | 2 | 1 | 0 |

| | | |
|---|---|---|
| Data bits | EOM | ACK |

TABLE 3
Header Block

| | | | | | | | |
|---|---|---|---|---|---|---|---|
| 3 | 2 | 1 | 0 | 3 | 2 | 1 | 0 |

| | | | |
|---|---|---|---|
| Initiator | Destination | EOM | ACK |

TABLE 4

| Address | Device |
|---|---|
| 0 | TV |
| 1 | Recording Device 1 |
| 2 | Recording Device 2 |
| 3 | Tuner 1 |
| 4 | Playback Device 1 |
| 5 | Audio System |
| 6 | Tuner 2 |
| 7 | Tuner 3 |
| 8 | Playback Device 2 |
| 9 | Recording Device 3 |
| 10 | Tuner 4 |
| 11 | Playback Device 3 |
| 12 | Reserved |
| 13 | Reserved |
| 14 | Specific Use |
| 15 | Unregistered (as Initiator address) |
| | Broadcast (as Destination address) |

Table 1 illustrates an example of the predetermined frame format, Table 2 illustrates an example of a header/data block format, Table 3 illustrates an example of a header block format, and Table 4 illustrates an example of the relationship between the address such as the logical address LA and the device. According to some embodiments, the predetermined frame format, the header/data block format, the header block format, and/or the relationship between the logical address LA and the device may vary. The predetermined frame format shown in Table 1 may be referred to as the CEC frame format, and may comprise the following partial frame formats (or fields):
(1) Start (or “the start bit format”), which may comprise a special start “bit” that may be implemented by way of at least one first predetermined waveform, for example, when an initiator is not transmitting any CEC message, the voltage on the CEC line may remain equal to a high voltage level, and when starting transmitting a CEC message, the initiator may drive the voltage on the CEC line according to the aforementioned at least one first predetermined waveform, and more particularly, pull down the CEC line voltage from the high voltage level to the low voltage level and then pull it up to the high voltage level and subsequently pull it back to the low voltage level, where upon receiving the partial message of this format, one or more followers will prepare to receive a plurality of data bits that are subsequently transmitted from the initiator;
(2) Header Block, which may comprise ten data bits as shown in Table 3, such as four initiator address bits for indicating the source such as the address of the initiator (labeled {3, 2, 1, 0} for brevity), four destination address bits for indicating the address of the destination (labeled {3, 2, 1, 0} for brevity), one bit for indicating the End of Message (EOM), and one bit for indicating the Acknowledgment (ACK), where the header block format shown in Table 3 may be regarded as a special case of the header/data block format shown in Table 2, and the last two bits shown in Table 2 (or Table 3) may be referred to as the EOM bit and the ACK bit, respectively;
(3) Data Block 1, which may comprise an opcode block, with the opcode block comprising ten data bits as shown in Table 2, such as eight information bits (labeled {7, 6, 5, 4, 3, 2, 1, 0} for brevity), the EOM bit, and the ACK bit, where the opcode block may carry an opcode in the information bits thereof; and
(4) Data Block 2, which may comprise one or more operand blocks, among which any operand block may comprise ten data bits as shown in Table 2, such as eight information bits, the EOM bit, and the ACK bit, where the one or more operand blocks may carry one or more operands in the information bits thereof;
where the plurality of data bits may be implemented by way of multiple other predetermined waveforms (e.g., at least one second predetermined waveform representing the logic value “0” (or “the logic 0”) and at least one third predetermined waveform representing the logic value “1” (or “the logic 1”)) which differ from the aforementioned at least one first predetermined waveform. For example, the initiator may use the logic value “0” and the logic value “1” to transmit data and set the ACK bit as the logic value “1”, and the one or more followers may respond the initiator with the ACK bit having the logic value “0” or the logic value “1” (depending on the current transmission mode), to indicate whether the information is successfully received. When the current transmission mode is a direct transmission mode, the one or more followers may comprise a single follower, the current message may be regarded as a direct message, and the single follower may set the ACK bit as the logic value “0” to indicate that the direct message is successfully received. When the current transmission mode is a broadcast transmission mode, the one or more followers may comprise a plurality of followers, the current message may be regarded as a broadcast message, and any follower among the plurality of followers may set the ACK bit as the logic value “0” to indicate that the broadcast message is not successfully received. Therefore, if the initiator detects an ACK value of 0 (i.e., ACK=0), the initiator may determine that at least one follower among the plurality of followers did not successfully receive the broadcast message; and if the initiator detects an ACK value of 1 (i.e., ACK=1), the initiator may determine that all followers among the plurality of followers have received the broadcast message correctly. In addition, an EOM bit value of 0 (i.e., EOM=0) may indicate that the current block to which the EOM bit belongs is not the last block in the current message, while an EOM bit value of 1 (i.e., EOM=1) may indicate that the current block to which the EOM bit belongs is the last block in the current message, signaling that the transmission of the current message has been completed. Additionally, the message size of the current message may be equal to the bit count of the plurality of data bits. When the current message comprises the header block, the opcode block, and the one or more operand blocks, the maximum message size thereof (or the maximum of the message size thereof) may be equal to (16*10) bits.

According to some embodiments, the first message may carry first CEC-related information, such as the frame contents (e.g., the source and the destination addresses, the opcode, and the operand(s)) carried in one or more partial frame formats (e.g., Header Block, Data Block 1, and Data Block 2) of the predetermined frame format shown in Table 1. The CEC virtual network 3 may utilize the VNB 210 to convert the first packet into the second message, to make the second message carry the first CEC-related information. For example, the ACK bit of the first message and the ACK bit of the second message may be equal to each other. The associated operations of the method may further comprise:
(1) the CEC virtual network 3 can utilize the VNB 210 to receive a third message from the aforementioned any remote device 200_k among the remote devices {200_k|k=1, 2, . . . } through the CEC line 6_1, where the third message conforms to the predetermined frame format;
(2) the CEC virtual network 3 can utilize the VNB 210 to convert the third message into a second packet, for performing the cross-CEC-line transmission;
(3) the CEC virtual network 3 can utilize the VNB 210 to transmit the second packet to the VNB 110;
(4) the CEC virtual network 3 can utilize the VNB 110 to convert the second packet into a fourth message, where the fourth message conforms to the predetermined frame format; and
(5) the CEC virtual network 3 can utilize the VNB 110 to transmit the fourth message to the aforementioned any first device 100_j among the first devices {100_j|j=1, 2, . . . } through the CEC line 6_0, to allow the remote device 200_k to indirectly perform the CEC communication with the first device 100_j via the cross-CEC-line transmission;
where the third message may carry second CEC-related information, such as the frame contents (e.g., the source and the destination addresses, the opcode, and the operand(s)) carried in one or more partial frame formats (e.g., Header Block, Data Block 1, and Data Block 2) of the predetermined frame format shown in Table 1. The CEC virtual network 3 may utilize the VNB 110 to convert the second packet into the fourth message, to make the fourth message carry the second CEC-related information. For example, the respective ACK bits of the third message and the fourth message may be equal to each other.

As shown in the left half part of FIG. 1, within the CEC network 5_0 corresponding to x=0, the first devices {100_1, 100_2, . . . } and the VNB 110 belong to the CEC network 5_0, and are coupled to each other through the CEC line 6_0. As shown in the right half part of FIG. 1, within any CEC network 5_x among the CEC networks {5_x|x>0} corresponding to x>0, taking x=1 as an example, the remote devices {200_1, 200_2, . . . } and the VNB 210 belong to the CEC network 5_1, and are coupled to each other through the CEC line 6_1. In the CEC virtual network 3, there is not any segment of CEC line coupled between the first CEC line such as the CEC line 6_0 and the second CEC line such as the CEC line 6_1. Based on the proposed method, the CEC virtual network 3 may utilize the multiple VNBs to perform the cross-CEC-line transmissions and the associated emulation operations, to allow the first device 100_j and the remote device 200_k to indirectly perform the CEC communication through the multiple VNBs. No matter whether the first device 100_j and the remote device 200_k respectively act as the initiator and the follower or respectively act as the follower and the initiator, the initiator may control the follower in accordance with various CEC functions. The CEC virtual network 3 (along with the first devices {100_1, 100_2, . . . }, the remote devices {200_1, 200_2, . . . }, and the VNB 110 and VNB 210, etc.) may comply with the CEC standard to perform the operations corresponding to various CEC functions.

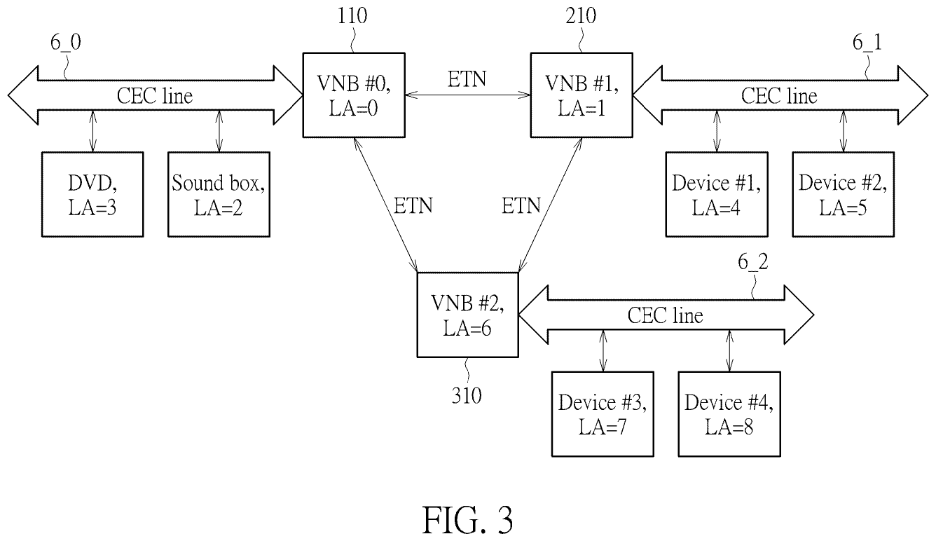

FIG. 3 illustrates a CoIP control scheme of the method according to an embodiment of the present disclosure. Any VNB (such as the VNB 110) among the multiple VNBs and at least one remaining VNB (such as the VNB 210 and VNB 310, etc.) may act/function as a master VNB and at least one slave VNB, respectively, and the master VNB such as VNB 110 may perform logical address configuration mentioned above on all the VNBs, the first devices {100_1, 100_2, . . . } such as the DVD player (labeled “DVD” for brevity) and the sound box/speaker), and the remote devices {200_1, 200_2, . . . } such as the devices #1 to #4), and more particularly, configure the VNB 110, the VNB 210, the sound box, the DVD player, the device #1, the device #2, the VNB 310, the device #3, and the device #4 to have the logical addresses {LA(i)|i=1, 2, 3, 4, 5, 6, 7, 8, 9} such as the logical addresses {LA(1)=0, LA(2)=1, LA(3)=2, LA(4)=3, LA(5)=4, LA(6)=5, LA(7)=6, LA(8)=7, LA(9)=8} (respectively labeled {LA=0, LA=1, . . . , LA=8} for brevity), to make the respective logical addresses {LA} of all devices corresponding to the CEC lines 6_0 to 6_2 be distinct from one another. The VNB 110 and the VNB 210 may be assigned the beginning logical addresses {0, 1}, and the VNBs 110 to 310 may be referred to as the VNB #0 to the VNB #2, respectively. According to some embodiments, the master VNB, the aforementioned at least one slave VNB, the first devices {100_1, 100_2, . . . }, the remote devices {200_1, 200_2, . . . }, and/or the logical addresses {LA} may vary.

Regarding the aforementioned any two CEC networks {5_x}, taking the CEC networks 5_0 and 5_1 as an example, assume that: the first device 100_j and the remote device 200_k represent the DVD player and the device #2, respectively; the first message and the third message represent a CEC command and a corresponding ACK, respectively; and the second message and the fourth message represent a virtual CEC command and a virtual ACK for emulating the CEC command and the corresponding ACK, respectively. This implies that the respective destination addresses of the CEC command and the virtual CEC command are both equal to the logical address of the device #2, i.e., LA(6)=5, and that the respective destination addresses of the corresponding ACK and the virtual ACK are both equal to the logical address of the DVD player, i.e., LA(4)=3. When the DVD player sends the CEC command, the VNB 110 may receive the CEC command and detect that its destination address is equal to the logical address of the device #2, i.e., LA(6)=5, and respond on behalf of the device #2 by sending the virtual ACK (which may comprise a header block, with this header block carrying the destination address such as LA(4)=3 and carrying the ACK bit such as ACK=0) to the DVD player, to emulate the operation of the device #2 replying to the DVD player with the corresponding ACK. For example, when the VNB 110 receives the EOM (e.g., EOM=1, which may indicate that the first CEC-related information carried in the CEC command has been fully received), a program module (e.g., a software or firmware module) running on the VNB 110 may, based on the interrupt triggering/modifying the flag receive_eom_ro, determine/indicate that the reception of the CEC command is completed, and access (e.g., read from) a VNB #1-dedicated CEC first in, first out (FIFO) buffer embedded in the VNB 110 (referred to as “the VNB_1 CEC FIFO” for brevity) to convert the first CEC-related information buffered in the VNB_1 CEC FIFO into the first packet. If the program module (e.g., the software or firmware module) running on the VNB 110 is unable to complete the above operations in time before another first device such as the sound box begins transmitting a new message such as a new CEC command whose destination address indicates that the new CEC command is intended to be sent to another remote device such as the device #1, then the VNB 110 may reject the new message such as the new CEC command and disallow the associated operations of the new CEC command. Upon beginning to receive the first packet, the VNB 210 may access (e.g., buffer or record/log) the transmitter/TX-side address tx_addr_ro=0x3, the receiver/RX-side address rx_addr_ro=0x5, and the relevant data carried in the first packet, for example, by using an address register and a FIFO buffer embedded in the VNB 210, respectively, until the EOM is received (e.g., EOM=1, which may indicate that the relevant data carried in the first packet has been fully received), and refer to the above information obtained from the first packet to generate the second message such as the virtual CEC command, to emulate the operation of the DVD player transmitting the CEC command to the device #2.

The respective communication interface circuits 111 and 211 of the VNB 110 and the VNB 210 may communicate with each other via wired and/or wireless communication, to allow these VNBs to perform packet exchange between them. For wired communication, the respective communication interface circuits 111 and 211 of the VNB 110 and the VNB 210 may comply with the Institute of Electrical and Electronics Engineers (IEEE) 802.3 standard and may be coupled to each other via an Ethernet cable (labeled “ETN” for brevity). For wireless communication, the respective communication interface circuits 111 and 211 of the VNB 110 and the VNB 210 may comply with the IEEE 802.11 standard and may be equipped with antennas. For brevity, similar descriptions for this embodiment are not repeated in detail here.

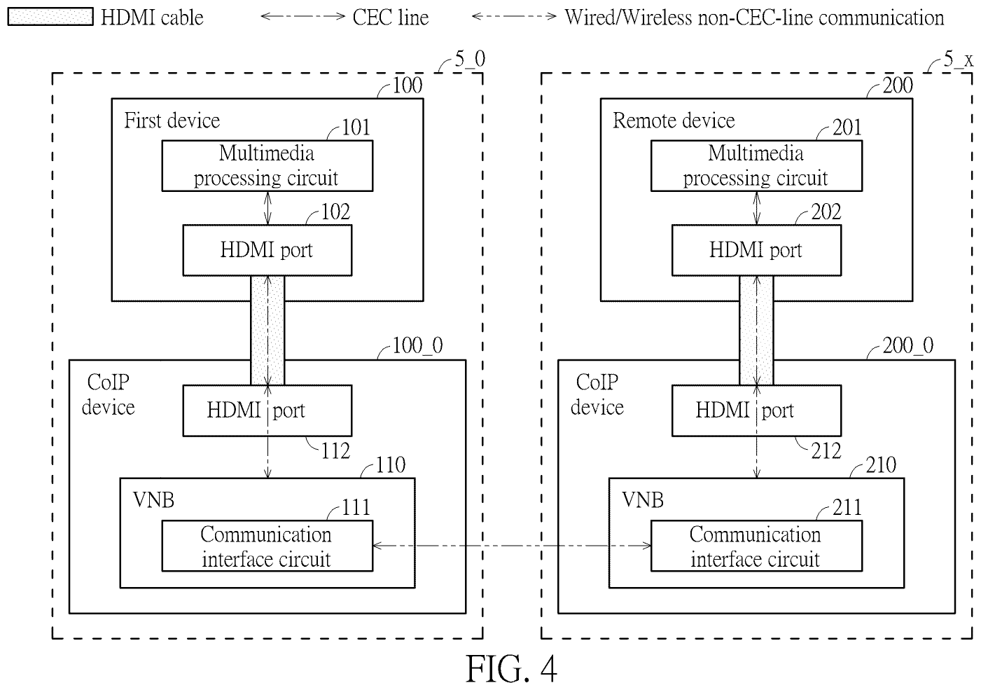

FIG. 4 illustrates a non-embedded VNB control scheme of the method according to an embodiment of the present invention, where multiple CoIP devices 100_0 and 200_0 involved with the non-embedded VNB control scheme can operate according to the method. The first device 100 and the remote device 200 can be taken as examples of the first device 100_j and the remote device 200_k mentioned above, respectively. The first device 100 may comprise a multimedia processing circuit 101 configured to perform multimedia processing, such as video/image processing and/or audio processing, for the first device 100, and may comprise an HDMI port 102 configured to couple other devices to the first device 100, and the remote device 200 may comprise a multimedia processing circuit 201 configured to perform multimedia processing, such as video/image processing and/or audio processing, for the remote device 200, and may comprise an HDMI port 202 configured to couple other devices to the remote device 200. The CoIP device 100_0 may comprise the VNB 110 configured to at least communicate with the remote device 200 through the VNB 210 for the first device 100, and may comprise at least one HDMI port 112 coupled to the VNB 110, for coupling at least the first device 100 to the CoIP device 100_0. The CoIP device 200_0 may comprise the VNB 210 configured to at least to communicate with the first device 100 through the VNB 110 for the remote device 200, and may comprise at least one HDMI port 212 coupled to the VNB 210, for coupling at least the remote device 200 to the CoIP device 200_0. The HDMI cable illustrated in the left half part of FIG. 4 may comprise a local CEC line of the CEC line 6_0 within the CEC network 5_0 corresponding to X=0, and the HDMI cable illustrated in the right half part of FIG. 4 may comprise a local CEC line of the CEC line 6_x (e.g., the CEC line 6_1, if x=1) within any CEC network 5_x(e.g., the CEC network 5_1, if x=1) among the CEC networks {5_x|x>0} corresponding to x>0. The respective communication interface circuits 111 and 211 of the VNB 110 and the VNB 210 may communicate with each other via wired and/or wireless non-CEC-line communication to implement the cross-CEC-line transmission. For brevity, similar descriptions for this embodiment are not repeated in detail here.

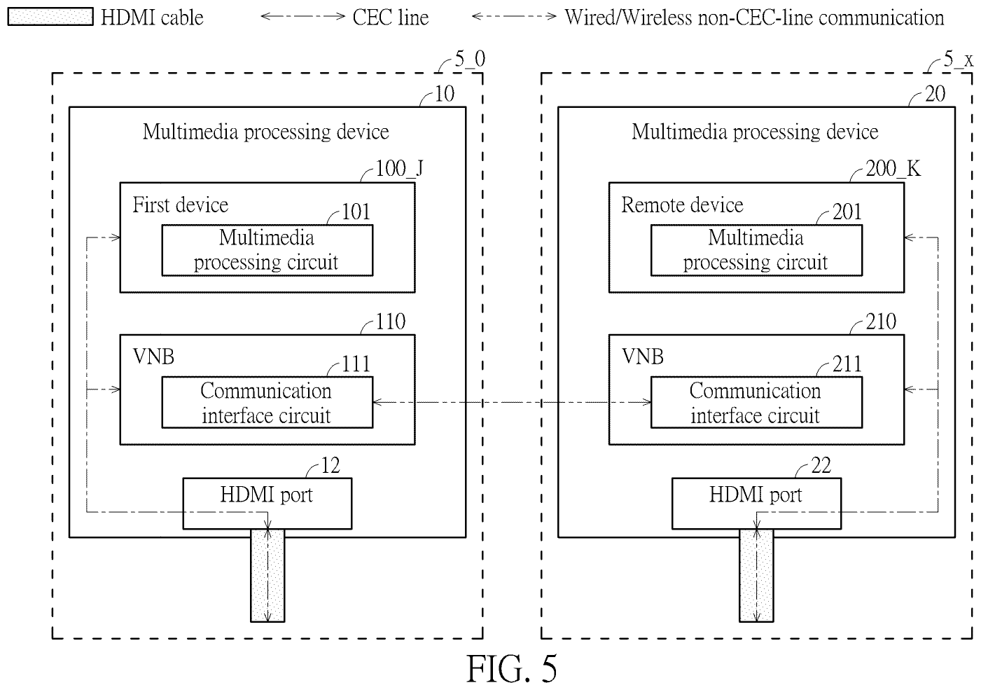

FIG. 5 illustrates an embedded VNB control scheme of the method according to an embodiment of the present invention, where multiple multimedia processing devices 10 and 20 involved with the embedded VNB control scheme can operate according to the method. The first device 100_J and remote device 200_K of this embodiment can be taken as examples of the first device 100_j and the remote device 200_k mentioned above, respectively. In comparison with the architecture shown in FIG. 4, the VNB 110 and the VNB 210 of this embodiment can be integrated into other devices such as the multimedia processing devices 10 and 20, respectively. The multimedia processing device 10 may comprise the first device 100_J configured to generate the first message for performing the CEC communication, and may comprise the VNB 110 configured to at least communicate with the remote device 200_K (and/or the other remote devices {200_k|k<K}) through the VNB 210 for the first device 100_J, and may further comprise at least one HDMI port 12 coupled to both the first device 100_J and the VNB 110, configured to couple at least another first device 100_j such as the other first devices {100_j|j<J} to the multimedia processing device 10. The multimedia processing device 20 may comprise the remote device 200_K configured to generate the third message for performing the CEC communication, and may comprise the VNB 210 configured to at least communicate with the first device 100_J (and/or the other first devices {100_j|j<J}) through the VNB 110 for the remote device 200_K, and may further comprise at least one HDMI port 22 coupled to both the remote device 200_K and the VNB 210, configured to couple at least another remote device 200_k such as the other remote devices {200_k|k<K} to the multimedia processing device 20. The first device 100_J may comprise the multimedia processing circuit 101 configured to perform multimedia processing, such as video/image processing and/or audio processing, for the first device 100_J, and the remote device 200_K may comprise the multimedia processing circuit 201 configured to perform multimedia processing, such as video/image processing and/or audio processing, for the remote device 200_K. The HDMI cable illustrated in the left half part of FIG. 5 may comprise a local CEC line of the CEC line 6_0 within the CEC network 5_0 corresponding to x=0, while the HDMI cable illustrated in the right half part of FIG. 5 may comprise a local CEC line of the CEC line 6_x (e.g., the CEC line 6_1, if x=1) within any CEC network 5_x(e.g., the CEC network 5_1, if x=1) among the CEC networks {5_x|x>0} corresponding to x>0. For brevity, similar descriptions for this embodiment are not repeated in detail here.

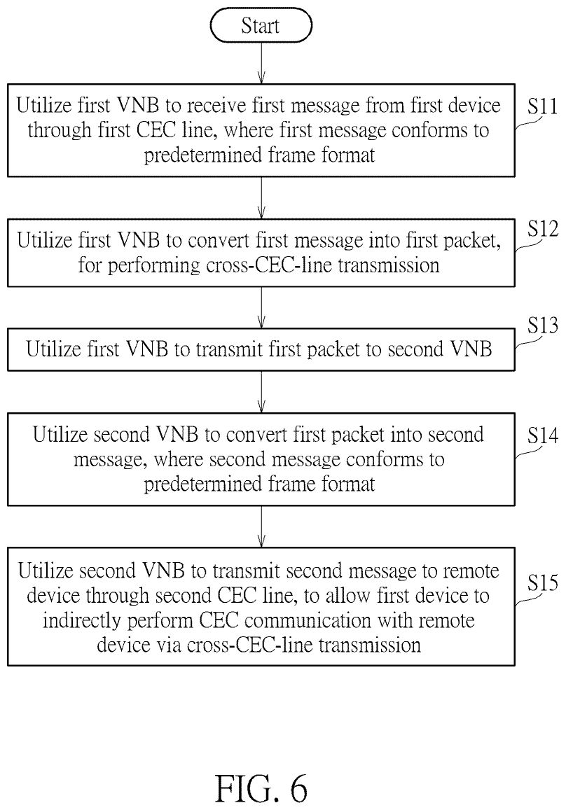

FIG. 6 illustrates a working flow of a VNB TX control scheme of the method according to an embodiment of the present invention.

In Step S11, the CEC virtual network 3 can utilize the first VNB such as the VNB 110 to receive the first message from the first device 100_j through the first CEC line such as the CEC line 6_0, where the first message conforms to the predetermined frame format.

In Step S12, the CEC virtual network 3 can utilize the first VNB such as the VNB 110 to convert the first message into the first packet, for performing the cross-CEC-line transmission.

In Step S13, the CEC virtual network 3 can utilize the first VNB such as the VNB 110 to transmit the first packet to the second VNB such as the VNB 210, where the first packet can be transmitted directly or indirectly from the VNB 110 to the VNB 210 (e.g., without or with routing through the VNB 310).

In Step S14, the CEC virtual network 3 can utilize the second VNB such as the VNB 210 to convert the first packet into the second message, where the second message conforms to the predetermined frame format.

In Step S15, the CEC virtual network 3 can utilize the second VNB such as the VNB 210 to transmit the second message to the remote device 200_k through the second CEC line such as the CEC line 6_1, to allow the first device 100_j to indirectly perform the CEC communication with the remote device 200_k via the cross-CEC-line transmission.

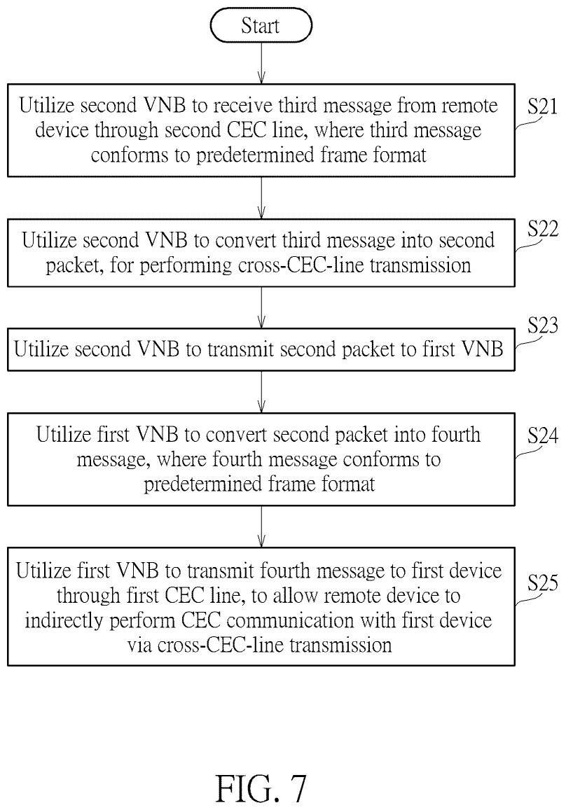

FIG. 7 illustrates a working flow of a VNB RX control scheme of the method according to another embodiment of the present invention.

In Step S21, the CEC virtual network 3 can utilize the second VNB such as the VNB 210 to receive the third message from the remote device 200_k through the second CEC line such as the CEC line 6_1, where the third message conforms to the predetermined frame format.

In Step S22, the CEC virtual network 3 can utilize the second VNB such as the VNB 210 to convert the third message into the second packet, for performing the cross-CEC-line transmission.

In Step S23, the CEC virtual network 3 can utilize the second VNB such as the VNB 210 to transmit the second packet to the first VNB such as the VNB 110, where the second packet can be transmitted directly or indirectly from the VNB 210 to the VNB 110 (e.g., without or with routing through the VNB 310).

In Step S24, the CEC virtual network 3 can utilize the first VNB such as the VNB 110 to convert the second packet into the fourth message, where the fourth message conforms to the predetermined frame format.

In Step S25, the CEC virtual network 3 can utilize the first VNB such as the VNB 110 to transmit the fourth message to the first device 100_j through the first CEC line such as the CEC line 6 0, to allow the remote device 200_k to indirectly perform the CEC communication with the first device 100_j via the cross-CEC-line transmission.

For example, if the first device 100_j and the remote device 200_k serve as the initiator and the follower, respectively, the working flow shown in FIG. 6 can be performed prior to the working flow shown in FIG. 7.

In another example, if the first device 100_j and the remote device 200_k serve as the follower and the initiator, respectively, the working flow shown in FIG. 6 can be performed after the working flow shown in FIG. 7.

According to some embodiments, any VNB among the multiple VNBs such as the VNB 110 and the VNB 210 may operate according to at least one control scheme of the method, such as the VNB TX control scheme and the VNB RX control scheme, so as to function as a TX VNB or an RX VNB. For example, the TX VNB may reconstruct the CEC command (which may comprise the header or the data block(s)) recorded by the peer VNB within the bridged CEC network, such as the RX VNB, and may transmit 1 to N sets of messages having configurable or fixed logical addresses in the headers thereof, where the header or the data block(s) of each message generated by the TX VNB may be configurable or fixed, and the information bits, the EOM bit, or the ACK bit of each message received by the TX VNB may be fully or partially recorded and directly or indirectly delivered back to the RX VNB within the bridged CEC network. In another example, the RX VNB may, based on the logical addresses, reconstruct the information bits, the EOM bit, or the ACK bit recorded by the peer VNB within the bridged CEC network, such as the TX VNB, and may receive 1 to N sets of messages having configurable or fixed logical addresses in the headers thereof, and record the data block(s) according to the logical addresses, where the content of the information bits, the EOM bit, or the ACK bit in each message replied by the RX VNB may be controllable or fixed, and the information bits of the header or the data block(s) in each message received by the RX VNB may be fully or partially recorded and directly or indirectly delivered to the TX VNB within the bridged CEC network.

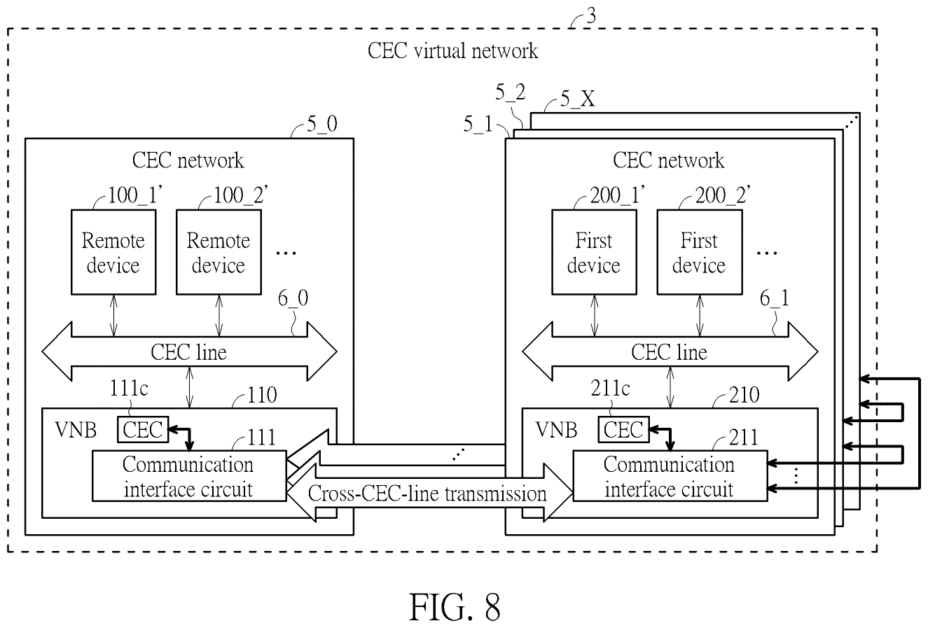

From the perspective of a given observer, any device within the CEC virtual network 3 may be regarded as either a local device or a remote device. FIG. 8 illustrates another version of the CEC virtual network 3 shown in FIG. 1, in response to a change in the observer's location. When the observer's location shifts from the CEC network 5_0 to the CEC network 5_1, the previously designated first devices {100_1, 100_2, . . . } are reclassified to be referred to as remote devices {100_1′, 100_2′, . . . }, while the previously designated remote devices {200_1, 200_2, . . . } are reclassified to be referred to as first devices {200_1′, 200_2′, . . . }.

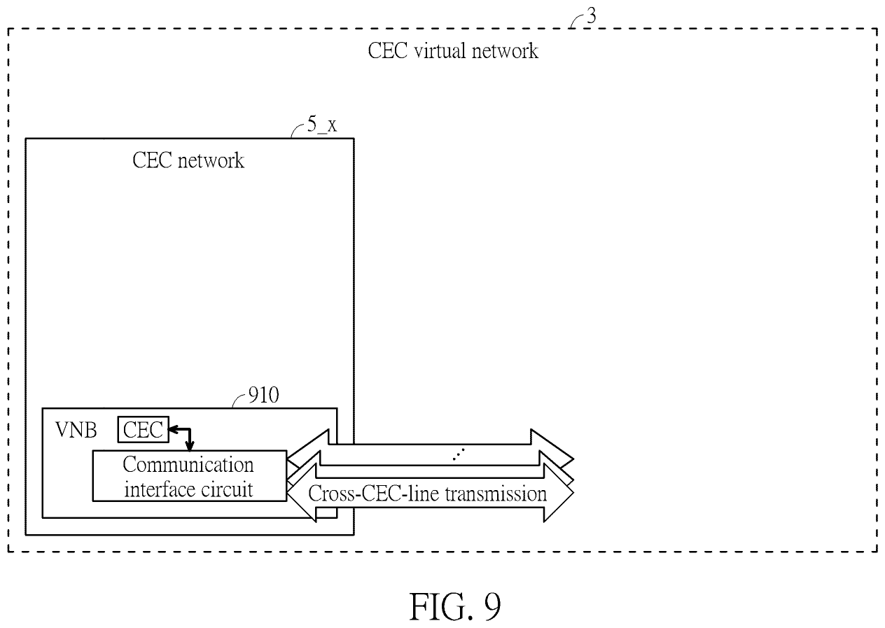

According to some embodiments, one or more VNBs among the multiple VNBs (such as all of the VNBs 110, 210, etc. in the architecture shown in FIG. 1 or FIG. 8) can be allowed to exist independently, i.e., without being connected to any CEC line or any first/remote device. Accordingly, the present invention provides a VNB capable of operating according to the proposed method, such as one of the multiple VNBs, where the VNB may exist independently without being connected to any CEC line or to any first or remote device, and is ready for use to operate like one of the first device and the remote device after being coupled to the aforementioned any first or remote device via the aforementioned any CEC line. The wired or wireless connection relationships based on the multiple VNBs may comprise a one-to-multiple relationship or a multiple-to-one relationship. FIG. 9 illustrates yet another version of the CEC virtual network 3 shown in FIG. 1. The VNB 910 may be regarded as one of the CEC devices, and may exist independently and perform cross-CEC-line transmission/communication with remote VNBs. The CEC network 5_x and the VNB 910 may respectively represent the CEC network 5 0 and the VNB 110 when x=0, or respectively represent the CEC network 5_1 and the VNB 210 when x=1. Examples of the one-to-multiple relationship may include, but are not limited to:
(1-1) in a situation where the CEC network 5_0 shown in FIG. 1 is modified to comprise only the VNB 110 (i.e., only the VNB 110 exists therein) like the CEC network 5_x shown in FIG. 9 with x=0, the relationship of the VNB 110 at the local side with respect to the VNB 210 and the remote devices {200_1, 200_2, . . . } at the remote side; and
(1-2) in a situation where the CEC network 5_1 shown in FIG. 8 is modified to comprise only the VNB 210 (i.e., only the VNB 210 exists therein) like the CEC network 5_x shown in FIG. 9 with x=1, the relationship of the VNB 210 at the local side with respect to the VNB 110 and the remote devices {100_1′, 100_2′, . . . } at the remote side.

Examples of the multiple-to-one relationship may include, but are not limited to:
(2-1) in a situation where the CEC network 5_1 shown in FIG. 1 is modified to comprise only the VNB 210 (i.e., only the VNB 210 exists therein) like the CEC network 5_x shown in FIG. 9 with x=1, the relationship of the VNB 110 and the first devices {100_1, 100_2, . . . } at the local side with respect to the VNB 210 at the remote side; and
(2-2) in a situation where the CEC network 5_0 shown in FIG. 8 is modified to comprise only the VNB 110 (i.e., only the VNB 110 exists therein) like the CEC network 5_x shown in FIG. 9 with x=0, the relationship of the VNB 210 and the first devices {200_1′, 200_2′, . . . } at the local side with respect to the VNB 110 at the remote side.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing consumer electronics control (CEC) communication with a remote device having a high-definition multimedia interface (HDMI) port with aid of multiple virtual network blocks (VNBs), the method comprising:
utilizing a first VNB among the multiple VNBs to receive a first message from a first device through a first CEC line, wherein the first message conforms to a predetermined frame format;
utilizing the first VNB to convert the first message into a first packet, for performing cross-CEC-line transmission;
utilizing the first VNB to transmit the first packet to a second VNB among the multiple VNBs, wherein the first packet is transmitted directly or indirectly from the first VNB to the second VNB;
utilizing the second VNB to convert the first packet into a second message, wherein the second message conforms to the predetermined frame format; and
utilizing the second VNB to transmit the second message to the remote device through a second CEC line, to allow the first device to indirectly perform the CEC communication with the remote device via the cross-CEC-line transmission.

2. The method of claim 1, wherein the first CEC line and the second CEC line are CEC lines independent of each other; a first set of devices comprise the first device and the first VNB, and are coupled to each other through the first CEC line; a second set of devices comprise the remote device and the second VNB, and are coupled to each other through the second CEC line; and the method further comprises:
performing logical address configuration on the first set of devices and the second set of devices, to make respective logical addresses of all devices corresponding to the first and the second CEC lines be different from each other, wherein said all devices comprise the first set of devices and the second set of devices.

3. The method of claim 1, wherein the first CEC line and the second CEC line are CEC lines independent of each other; a first set of devices comprise the first device and the first VNB, and are coupled to each other through the first CEC line; a second set of devices comprise the remote device and the second VNB, and are coupled to each other through the second CEC line; and the method further comprises:
utilizing the first and second VNBs to emulate operations of the remote device for the first device in accordance with the predetermined frame format to make the first device regard the remote device as being on the first CEC line, and to emulate operations of the first device for the remote device in accordance with the predetermined frame format to make the remote device regard the first device as being on the second CEC line, to allow the first device to indirectly perform the CEC communication with the remote device via the cross-CEC-line transmission.

4. The method of claim 1, further comprising:
utilizing the second VNB to receive a third message from the remote device through the second CEC line, wherein the third message conforms to the predetermined frame format;
utilizing the second VNB to convert the third message into a second packet, for performing the cross-CEC-line transmission;
utilizing the second VNB to transmit the second packet to the first VNB, wherein the second packet is transmitted directly or indirectly from the second VNB to the first VNB;
utilizing the first VNB to convert the second packet into a fourth message, wherein the fourth message conforms to the predetermined frame format; and
utilizing the first VNB to transmit the fourth message to the first device through the first CEC line, to allow the remote device to indirectly perform the CEC communication with the first device via the cross-CEC-line transmission.

5. The method of claim 1, wherein the first device and the first VNB belong to a first CEC network, and are coupled to each other through the first CEC line; the remote device and the second VNB belong to a second CEC network, and are coupled to each other through the second CEC line; and there is not any segment of CEC line coupled between the first CEC line and the second CEC line.

6. A consumer electronics control (CEC) over internet protocol (CoIP) device that operates according to the method of claim 1, the CoIP device comprising:
the first VNB, configured to at least perform communication with the remote device through the second VNB for the first device, the first VNB comprising:
a first communication interface circuit, configured to communicate with a second communication interface circuit within the second VNB for the first VNB, to allow the first and the second VNBs to perform packet exchange; and
at least one HDMI port, coupled to the first VNB, configured to at least connect the first device to the CoIP device.

7. A multimedia processing device that operates according to the method of claim 1, the multimedia processing device comprising:
the first device, configured to generate the first message, for performing the CEC communication, the first device comprising:
a multimedia processing circuit, configured to perform multimedia processing for the multimedia processing device, wherein the multimedia processing comprises at least one of image processing and audio processing;
the first VNB, coupled to the first device, configured to at least perform communication with the remote device through the second VNB for the first device, the first VNB comprising:
a first communication interface circuit, configured to communicate with a second communication interface circuit within the second VNB for the first VNB, to allow the first and the second VNBs to perform packet exchange; and
a first HDMI port, coupled to the first device and the first VNB, configured to connect another device to the multimedia processing device.

8. A CEC virtual network that operates according to the method of claim 1, wherein the CEC virtual network comprises the first device, the remote device, and the multiple VNBs.

9. A virtual network block (VNB), for performing consumer electronics control (CEC) communication, wherein the virtual network block is one of multiple VNBs, and exists independently without being connected to any CEC line or to any first or remote device, and is ready for use to perform cross-CEC-line transmission for said any first or remote device after being coupled to said any first or remote device via said any CEC line.

10. The VNB of claim 9, wherein wired or wireless connection relationships based on the multiple VNBs comprise one of a one-to-multiple relationship and a multiple-to-one relationship, and wherein the remaining VNBs among the multiple VNBs, excluding the VNB, comprise a first VNB and a second VNB, for performing the following operations:
the first VNB receives a first message from a first device through a first CEC line, wherein the first message conforms to a predetermined frame format;
the first VNB converts the first message into a first packet, for performing cross-CEC-line transmission;
the first VNB transmits the first packet to the second VNB;
the second VNB converts the first packet into a second message, wherein the second message conforms to the predetermined frame format; and
the second VNB transmits the second message to the remote device through a second CEC line, to allow the first device to indirectly perform the CEC communication with the remote device via the cross-CEC-line transmission.
